(19) United States
(12) Patent Application Publication
(10) Pub. No.: US 2014/0317541 A1
(43) Pub. Date: Oct. 23, 2014

(54) ELECTRONIC DEVICE HAVING TOUCH SCREEN AND METHOD FOR ZOOMING IN

(71) Applicants: Fu Tai Hua Industry (Shenzhen) Co., Ltd., Shenzhen (CN); HON HAI PRECISION INDUSTRY CO., LTD., New Taipei (TW)

(72) Inventors: HAI-SHENG LI, Shenzhen (CN); CHIH-SAN CHIANG, New Taipei (TW); YU-DA XU, Shenzhen (CN); ZHAO-PING ZHANG, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 14/257,065

(22) Filed: Apr. 21, 2014

(30) Foreign Application Priority Data
Apr. 22, 2013 (CN) 201310139763X

(51) Int. Cl. G06F 3/0484; G06F 3/0483; G06F 3/0488

(52) U.S. Cl. CPC G06F 3/04845; G06F 3/04842; G06F 3/04883; G06F 3/0483
USPC 715/764

(57) ABSTRACT

A method for zooming in content displayed on a touch screen comprises detecting the touch track of a touch on the touch screen and determining whether the touch track encloses a graphic. A current display mode of the touch screen when the touch track does enclose a graphic is identified and the content within the bounds of the enclosed graphic according to the current display mode of the touch screen is magnified. An electronic device using the above method is also provided.

### FIELD

The present disclosure relates to electronic devices, and particularly to an electronic device having a touch screen and a method thereof for zooming into the content.

### BACKGROUND

Electronic devices equipped with a touch screen are widespread. However, changing the size of any displayed content on the touch screen requires several operations and is inconvenient.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an embodiment of an electronic device.

FIG. 2A is a diagrammatic view of a first embodiment of an interface displayed on the touch screen of electronic devices in a one-page mode, such as the one of FIG. 1.

FIG. 2B is a diagrammatic view of an interface showing zoomed in content on the touch screen of FIG. 2A.

FIG. 3A is a diagrammatic view of a second embodiment of an interface displayed on the touch screen of electronic devices in a multi-page mode, such as the one of FIG. 1.

FIG. 3B is a diagrammatic view of an interface showing one page magnified by zooming on the touch screen of FIG. 3A.

FIG. 4 is a flowchart of a method for zooming in content displayed on a touch screen.

### DETAILED DESCRIPTION

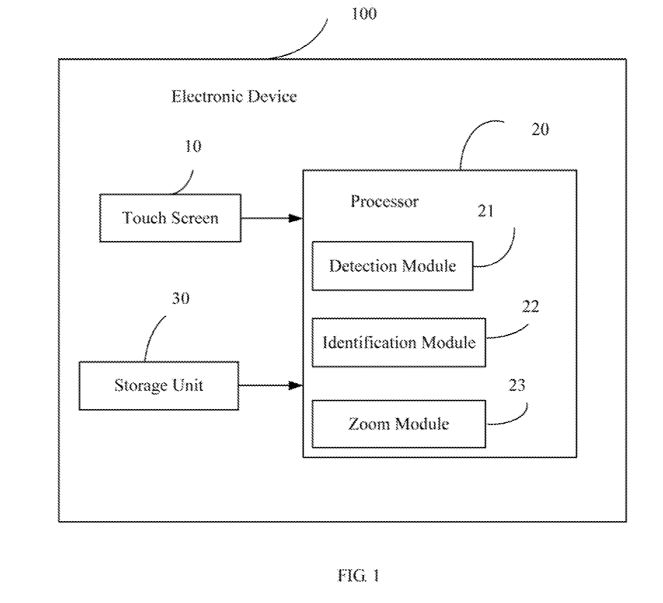

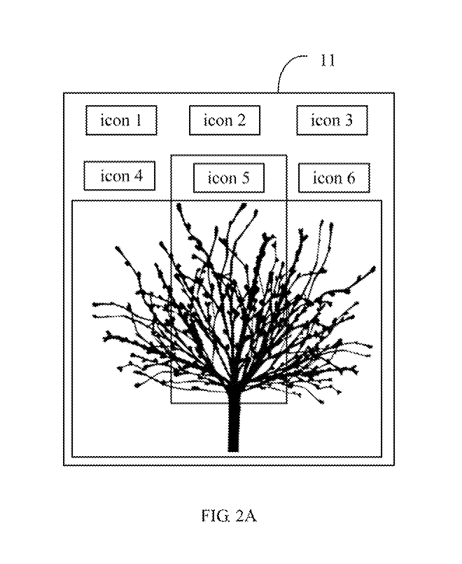

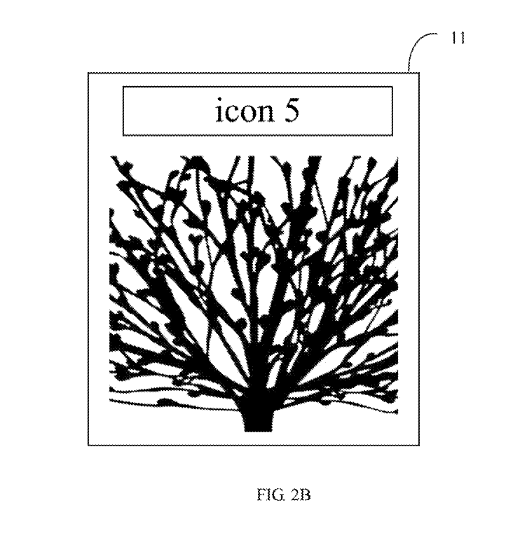

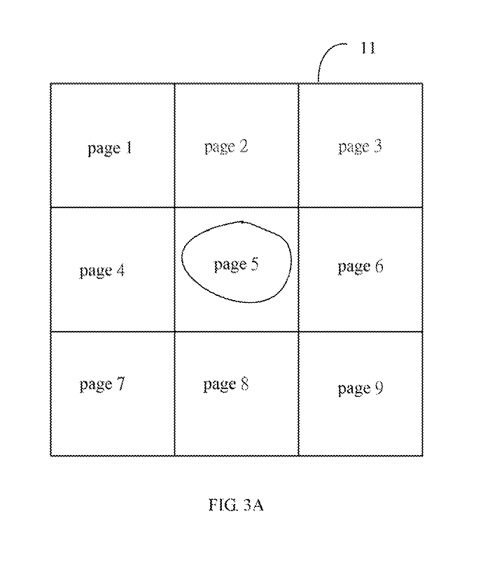

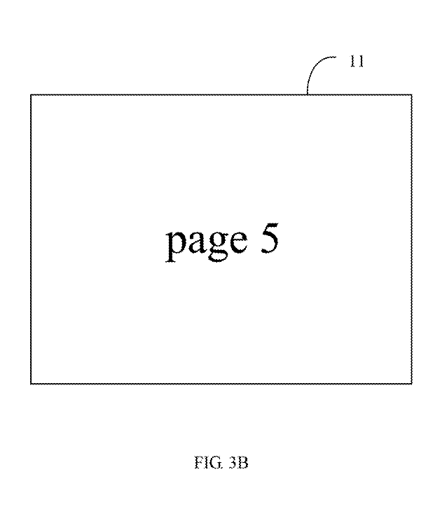

FIG. 1 illustrates an electronic device 100. The electronic device 100 includes a touch screen 10, a processor 20 and a storage unit 30. The touch screen 10 includes a display region 11 (shown in FIGS. 2A, 2B, 3A, and 3B). The storage unit 30 stores various files, such as images, icons, and text files, in their own format. The content displayed on the display region 11 of the touch screen 10 is formed by one or more files stored in the storage unit 30.

The processor 20 includes a detection module 21, an identification module 22, and a zoom module 23.

The detection module 21 detects the touch track of a touch operation applied on the touch screen 10 and determines whether the touch track encloses an enclosure of a graphic. In at least one embodiment, the enclosed graphic includes a center point, and the border of the graphic being a distance from the center point. The enclosed graphic can be rectangular, a circle, triangular, or other shape.

The identification module 22 identifies a current display mode of the touch screen 10 and the content bounded by the enclosed graphic. In at least one embodiment, the display mode of the touch screen 100 includes a one-page mode and a multi-page mode. In the one page mode, the touch screen 10 only displays a single page over the whole display region 11 of the touch screen 10. In the multi-page mode, the touch screen 10 displays more than one page at one time over the whole display region 11 of the touch screen 10.

When the touch track encloses an enclosed graphic, the zoom module 23 zooms in the content bounded by the enclosure according to the current display mode of the touch screen 10. FIGS. 2A and 2B show that when the touch screen 10 is in the one-page mode, the zoom module 23 zooms in the content bounded by the enclosed graphic, to occupy the whole display region 11 of the touch screen 10. FIGS. 3A and 3B show that when the touch screen 10 is in the multi-page mode, the zoom module 23 zooms in a complete page, at least a part of which is within the enclosure, to occupy the whole display region 11 of the touch screen 10.

In an alternative embodiment, when the touch screen 10 is in the one-page mode, the zoom module 23 calculates a magnification of the content within the enclosed graphic according to the size of the enclosed graphic and the size of the display region 11 of the touch screen and zooms in the bounded content according to the calculated magnification.

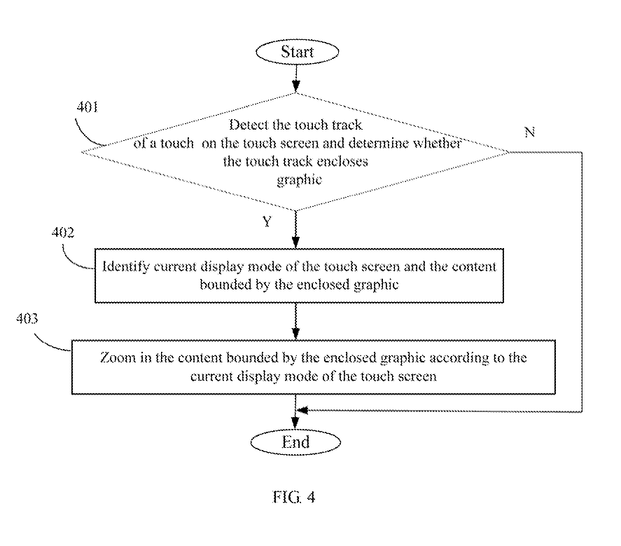

FIG. 4 illustrates a flowchart of a method for zooming in the content displayed on the touch screen. The method is applied to the electronic device 100 and includes steps, each of which is related to the various components contained in the electronic device 100.

In block 401, the detection module 21 detects the touch track of a touch operation applied on the touch screen 10 and determines whether the touch track encloses an enclosure of a graphic; if the touch trace encloses a graphic, the process goes to block 402; if the touch track does not enclose a graphic, the process ends.

In at least one embodiment, the detection module 21 determines whether the graphic associating with the touch track comprises a center point and the border of the graphic is a distance away from the center point.

In block 402, the identification module 22 identifies a current display mode of the touch screen 10 and the content bounded by the enclosed graphic.

In at least one embodiment, the display mode of the touch screen 10 includes a one-page mode and a multi-page mode.

In block 403, the zoom module 23 zooms in the content bounded by the enclosure according to the current display mode of the touch screen 10.

In at least one embodiment, when the touch screen 10 is in the multi-page mode, the zoom module 23 zooms in a complete page that the enclosure is on; when the touch screen 10 is under the one-page mode, the zoom module 23 zooms in the content bounded by the enclosure.

In an alternative embodiment, when the touch screen 100 is in the one-page mode, the zoom module 23 calculates a magnification of the bounded content for display according to the size of the enclosed graphic and the size of the display region 11 of the touch screen 10 and zooms in the bounded content according to the calculated magnification.

The electronic device 100 enlarges the displayed content or part of it when the touch trace on the touch screen 10 encloses a graphic, thus requiring only one operation by the user to zoom in the required content.

Although the present disclosure has been described with reference to certain embodiments, persons having ordinary skill in the art may make various modifications and changes without departing from the scope of the disclosure. Therefore, the scope of the appended claims should not be limited to the description of the preferred embodiments described above.

What is claimed is:

1. A method for zooming in content displayed on a touch screen, the method comprising:
detecting a touch track of a touch on the touch screen;
determining whether the touch track encloses an enclosed graphic;
identifying a current display mode of the touch screen when the touch track encloses an enclosed graphic;
zooming in the content bounded by the enclosed graphic according to the current display mode of the touch screen.

2. The method described as in claim 1, wherein the display mode of the touch screen is selected from a group consisting of: a one-page mode and a multi-page mode.

3. The method described as in claim 2, wherein zooming in comprises zooming in a complete page that at least a part of which is within the enclosed graphic when the touch screen is under the multi-page mode.

4. The method described as in claim 2, wherein zooming in comprises zooming in the content bounded by the enclosed graphic when the touch screen is under the one-page mode.

5. The method described as in claim 4, further comprising calculating a magnification of the bounded content according to the size of the enclosed graphic and the size of the display region of the touch screen.

6. The method described as in claim 5, wherein the zooming in step further comprises zooming in the bounded content according to the calculated magnification.

7. The method described as in claim 1, wherein the step determining whether the touch track encloses an enclosed graphic comprises determining whether the graphic associating with the touch track comprises a center point and the border of the graphic is a distance from the center point.

8. An electronic device comprising:
a touch screen; and
a processor including:
a detection module configured to detect the touch track of a touch on the touch screen and determine whether the touch track encloses an enclosed graphic
an identification module configured to identify a current display mode of the touch screen when the touch track encloses an enclosed graphic;
a zoom module configured to zoom in the displayed content bounded by the enclosed graphic according to the current display mode of the touch screen.

9. The electronic device described as in claim 8, wherein the current display mode of the touch screen is selected from a group consisting of: a one-page mode and a multi-page mode.

10. The electronic device described as in claim 9, wherein the zoom module zooms in a complete page that at least a part of which is within the enclosed graphic when touch screen is under the multi-page mode.

11. The electronic device described as in claim 9, wherein the zoom module zooms in the content bounded by the enclosed graphic when the touch screen is under the one-page mode.

12. The electronic device described as in claim 11, wherein the zoom module is configured to calculate a magnification of the bounded content according to the size of the enclosed graphic and the size of the display region of the touch screen.

13. The electronic device described as in claim 12, wherein the zoom module zooms in the bounded content according to the calculated magnification.

14. The electronic device described as in claim 13, wherein the enclosed graphic comprises a center point and the border of the graphic is a distance from the center point.

15. The electronic device described as in claim 13, wherein the enclosed graphic is selected from a group consisting of: a rectangular, a circle and a triangular.
